(19) United States
(12) Patent Application Publication
(10) Pub. No.: US 2025/0035204 A1
(43) Pub. Date: Jan. 30, 2025

(54) GEAR CONNECTION STRUCTURE CONNECTING ROTARY SHAFT WITH PIN, DRIVE DEVICE, AND IMAGE FORMING APPARATUS

(71) Applicant: KYOCERA Document Solutions Inc., Osaka (JP)

(72) Inventor: Tomoyasu YAMADA, Osaka (JP)

(73) Assignee: KYOCERA Document Solutions Inc., Osaka (JP)

(21) Appl. No.: 18/786,076

(22) Filed: Jul. 26, 2024

(30) Foreign Application Priority Data
Jul. 28, 2023 (JP) 2023-123425

(51) Int. Cl. F16H 57/00; F16D 1/108; G03G 15/00

(52) U.S. Cl. CPC F16H 57/0025; F16D 1/108; G03G 15/757; F16D 2300/12

(57) ABSTRACT

A gear connection structure included in a drive device of a document conveyance device includes: a rotary shaft extending in an axial direction thereof; a parallel pin inserted through a pin hole formed in the rotary shaft, the pin hole passing through the rotary shaft in a radial direction thereof orthogonal to the axial direction; a gear; and a biasing member. The gear includes: a shaft hole through which the rotary shaft is passed; and a pin groove inside which the parallel pin is placed. The biasing member biases the parallel pin placed inside the pin groove from a separate wall being one of a pair of walls of the pin groove toward a contacting wall being the other of the pair of walls to press the parallel pin against the contacting wall and against a side of an inner periphery of the pin hole close to the contacting wall.

### INCORPORATION BY REFERENCE

This application claims priority to Japanese Patent Application No. 2023-123425 filed on Jul. 28, 2023, the entire contents of which are incorporated by reference herein.

### BACKGROUND

The present disclosure relates to gear connection structures, drive devices, and image forming apparatuses.

There is known a gear connecting mechanism in which a metallic parallel pin passed through a pin through hole in a roller shaft is held inside a groove provided on a side surface of a gear made of synthetic resin. A pair of projections are provided on one of both sidewalls of the groove and on opposite sides across a shaft through hole of the gear through which the roller shaft is passed. The projections tightly contact the parallel pin, press the parallel pin against the other (opposite) sidewall of the groove, and also press the parallel pin against a portion of the inner periphery of the pin through hole located on the opposite side to the projections. Thus, the oscillation (micro movement) of the parallel pin in the pin through hole and the groove can be suppressed.

### SUMMARY

A technique improved over the aforementioned technique is proposed as one aspect of the present disclosure.

A gear connection structure according to an aspect of the present disclosure includes a rotary shaft, a parallel pin, a gear, and a biasing member. The rotary shaft extends in an axial direction thereof. The parallel pin is inserted through a pin hole formed in the rotary shaft, the pin hole passing through the rotary shaft in a radial direction thereof orthogonal to the axial direction. The gear includes: a shaft hole through which the rotary shaft is passed; and a pin groove inside which the parallel pin is placed. The biasing member biases the parallel pin placed inside the pin groove from a separate wall being one of a pair of walls of the pin groove toward a contacting wall being the other of the pair of walls to press the parallel pin against the contacting wall and against a side of an inner periphery of the pin hole close to the contacting wall.

A drive device according to another aspect of the present disclosure includes: the gear connection structure according to the above aspect of the present disclosure; and a driver that rotates the rotary shaft.

An image forming apparatus according to still another aspect of the present disclosure includes the drive device according to the other aspect of the present disclosure.

### BRIEF DESCRIPTION OF THE DRAWINGS

FIG. 1 is a schematic view (front view) showing an internal structure of an image forming apparatus according to one embodiment of the present disclosure.

FIG. 2 is a plan view showing a drive device according to the one embodiment of the present disclosure.

FIG. 3 is a perspective view showing the drive device according to the one embodiment of the present disclosure.

FIG. 4 is a front view showing a gear connection structure according to the one embodiment of the present disclosure.

FIG. 5 is a cross-sectional view taken along the line V-V in FIG. 4.

FIG. 6 is a cross-sectional view showing a gear connection structure according to a first modification of the one embodiment of the present disclosure.

FIG. 7 is a perspective view showing a gear connection structure according to a second modification of the one embodiment of the present disclosure.

FIG. 8 is a front view showing the gear connection structure according to the second modification of the one embodiment of the present disclosure.

FIG. 9 is a cross-sectional view taken along the line IX-IX in FIG. 8.

FIG. 10 is a front view showing a gear connection structure according to a third modification of the one embodiment of the present disclosure.

FIG. 11 is a cross-sectional view taken along the line XI-XI in FIG. 10.

### DETAILED DESCRIPTION

Hereinafter, a description will be given of a gear connection structure, a drive device, and an image forming apparatus according to an embodiment as one aspect of the present disclosure with reference to the drawings. The symbols Fr, Rr, L, R, U, and D shown in the drawings represent front, rear, left, right, upward, and downward, respectively. It should be understood that, although terms representing directions and terms representing locations are used herein, these terms are merely for explanatory purposes and are not intended to limit the technical scope of the present disclosure.

### [Image Forming Apparatus]

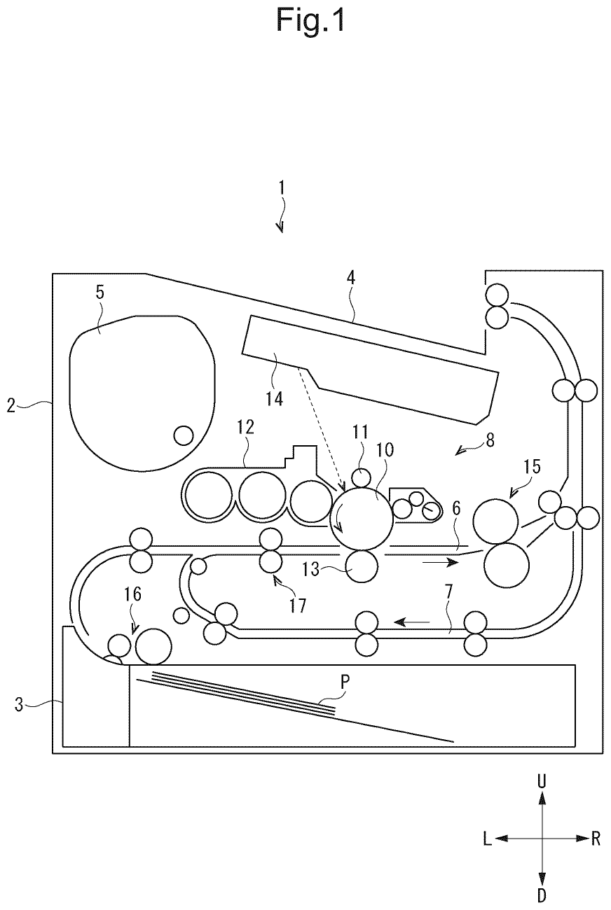

An image forming apparatus 1 will be described with reference to FIG. 1. FIG. 1 is a schematic view (front view) showing an internal structure of the image forming apparatus 1.

The image forming apparatus 1 includes an apparatus body 2 forming an approximately cuboid appearance. The inside bottom of the apparatus body 2 is provided with a sheet feed cassette 3 for use to accommodate paper sheets P (media) and the sheet feed cassette 3 is removable from the apparatus body 2. A sheet output tray 4 is provided on the top surface of the apparatus body 2. An upper left portion of the interior of the apparatus body 2 is provided with a toner container 5 containing, for example, a black toner (a developer).

A conveyance path 6 and a turnover conveyance path 7 are formed in the interior of the apparatus body 2 to serve as paths along which a paper sheet P is conveyed. The conveyance path 6 is a path formed in a substantially S-shape for the purpose of conveying the sheet P from the sheet feed cassette 3 to the sheet output tray 4. The turnover conveyance path 7 is branched from the conveyance path 6 in the downstream side of the conveyance path 6 and joins an upstream side of the conveyance path 6. The turnover conveyance path 7 is a path for use in turning over the sheet P and conveying it again to an image forming device 8 to be described hereinafter. In the description of the image forming apparatus 1, the terms “upstream”, middle”, and “downstream” refer to “upstream”, middle”, and “downstream” in the direction of conveyance of the sheet P (medium).

The image forming apparatus 1 includes an image forming device 8 that forms an image on a sheet P in an electrophotographic manner. The image forming device 8 includes a photosensitive drum 10, a charging device 11, a developing device 12, a transfer roller 13, an optical scanning device 14, and a fixing device 15.

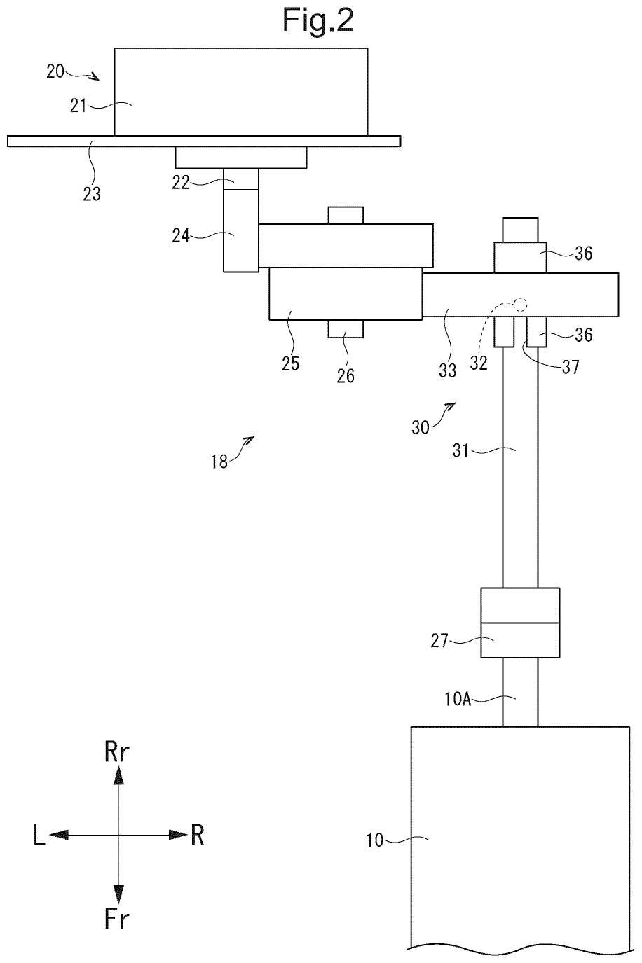

The photosensitive drum 10 (a rotating body) is provided in a middle section of the conveyance path 6. The photosensitive drum 10 includes a photosensitive layer laid on an outer peripheral surface of a bare metal drum and is formed in a cylindrical shape elongated in a front-to-rear direction. A drum shaft 10A (see FIG. 2) of the photosensitive drum 10 is supported rotatably about an axis thereof by a pair of support metal plates (not shown) disposed on both the front and rear sides of the drum shaft 10A.

A sheet feed device 16 is provided at the upstream end of the conveyance path 6 and a registration roller pair 17 is provided in the middle section of the conveyance path 6 (upstream of the photosensitive drum 10). The charging device 11, the developing device 12, and the transfer roller 13 are arranged in the order of an image formation process around the photosensitive drum 10. The transfer roller 13 is in contact with the photosensitive drum 10 from below to form a transfer nip between them. The optical scanning device 14 is provided above the photosensitive drum 10. The fixing device 15 is provided in a downstream side of the conveyance path 6.

The image forming apparatus 1 is provided with a controller (not shown) for appropriately controlling various components to be controlled. The controller includes a processor or the like that executes various types of arithmetic processing in accordance with programs and parameters stored in a memory. The image forming apparatus 1 is further provided with a display input device (not shown), such as a touch panel or buttons, through which the user (operator) inputs various instructions. The display input device is electrically connected to the controller, sends an input signal to the controller, and receives an electric signal (for example, data to be displayed on the touch panel) sent from the controller.

### [Image Formation Processing]

A description will be given below of the operation of the image forming apparatus 1. The controller executes image formation processing in the following manner, for example, based on image data input from an external terminal.

The charging device 11 electrically charges the surface of the photosensitive drum 10 and the optical scanning device 14 emits scanning light based on image data to form an electrostatic latent image on the surface (the photosensitive layer) of the photosensitive drum 10. The developing device 12 uses a toner supplied from the toner container 5 to develop a toner image on the surface of the photosensitive drum 10. The sheet feed device 16 feeds sheets P one by one from the sheet feed cassette 3 to the conveyance path 6. The sheet P is conveyed along the conveyance path 6, is corrected in terms of skew by the registration roller pair 17, and then enters the transfer nip. The transfer roller 13 transfers the toner image on the photosensitive drum 10 to the sheet P passing through the transfer nip and the fixing device 15 thermally fixes the toner image on the sheet P. In the case of single-sided printing, the sheet P is then ejected onto the sheet output tray 4.

In the case of double-sided printing, the sheet P is switched back at the downstream end of the conveyance path 6, conveyed along the turnover conveyance path 7, and then returned to the conveyance path 6. Thereafter, through the same process as described above, an image is formed on the back side of the sheet P and the sheet P printed on both sides is ejected to the sheet output tray 4.

### [Drive Device]

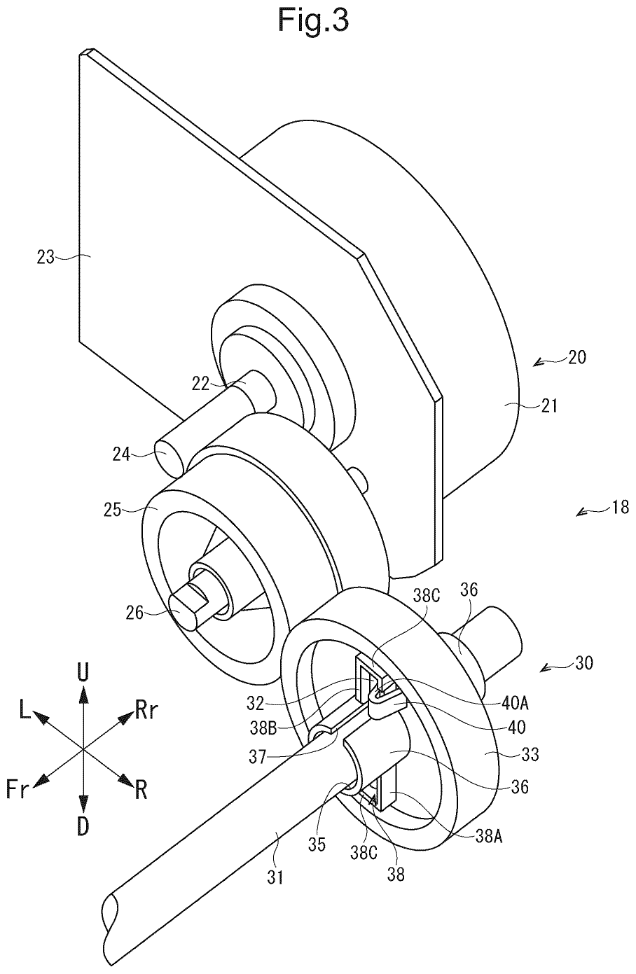

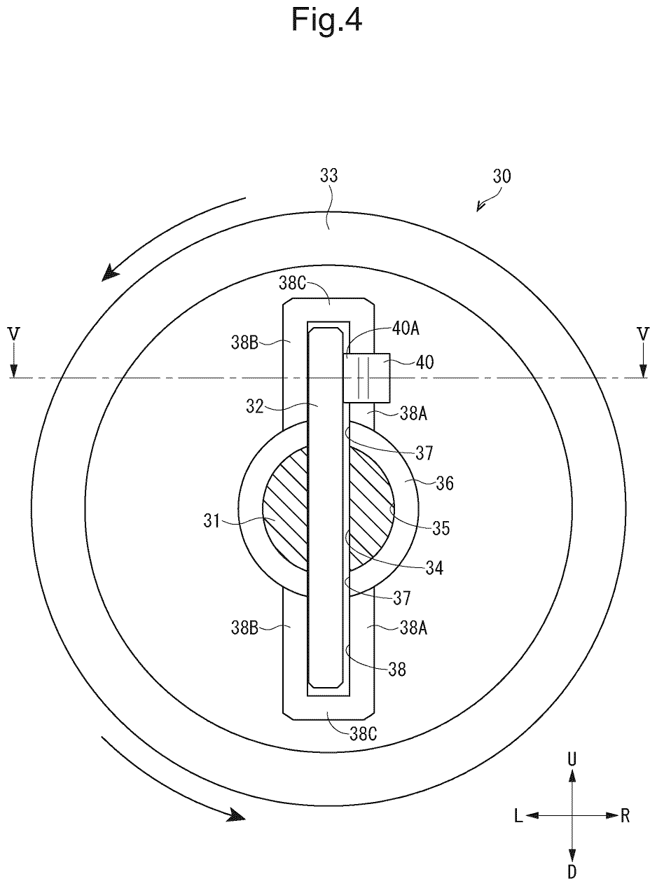

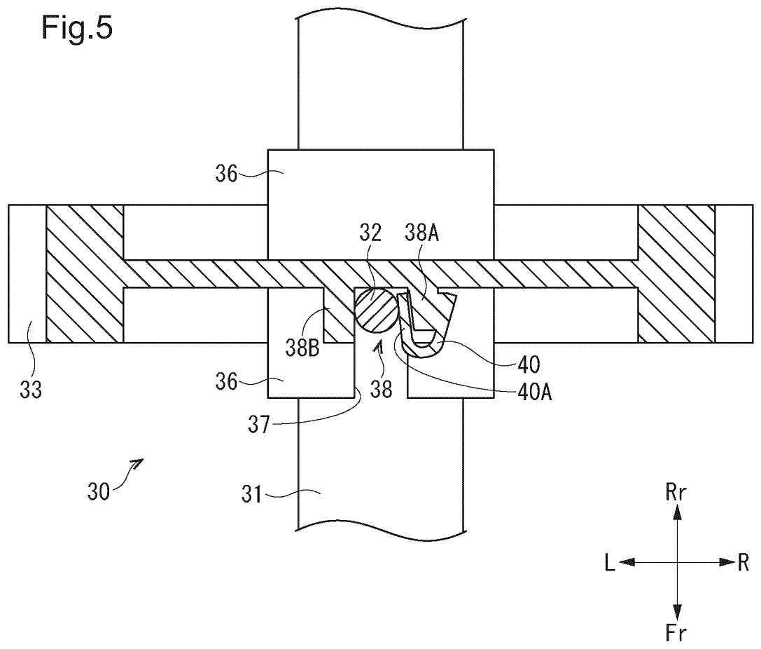

Next, a description will be given of the drive device 18 with reference to FIGS. 2 to 5. FIG. 2 is a plan view showing the drive device 18. FIG. 3 is a perspective view showing the drive device 18. FIG. 4 is a front view showing a gear connection structure 30. FIG. 5 is a cross-sectional view taken along the line V-V in FIG. 4.

As shown in FIG. 2, the image forming apparatus 1 is provided with the drive device 18 that rotates the photosensitive drum 10. The drive device 18 is provided rearward of the photosensitive drum 10. The drive device 18 includes a driver 20 and a gear connection structure 30.

### <Driver>

The driver 20 is, for example, a DC motor, is electrically connected to the controller that performs overall control of the image forming apparatus 1, and controlled in terms of driving by the controller. As shown in FIGS. 2 and 3, the driver 20 includes: a drive body 21 containing a stator and a rotor (both not shown); and a drive shaft 22 extending from the axis of the rotor. The drive body 21 is secured to a rear surface of a drive metal plate 23. The drive shaft 22 is formed in a columnar (round bar) shape and supported rotatably about an axis thereof through a bearing (not shown) by the drive body 21. The drive shaft 22 passes through an opening (not shown) formed in the drive metal plate 23 and extends out of the front surface of the drive metal plate 23. A pinion gear 24 meshing with an idler gear 25 is fixed at a distal end of the drive shaft 22. The idler gear 25 is, for example, a stepped gear and the pinion gear 24 is, for example, a spur gear meshing with a large-diameter portion of the idler gear 25. The idler gear 25 is fixed to an idler shaft 26 supported rotatably about an axis thereof by a metal plate (not shown).

### <Gear Connection Structure>

As shown in FIG. 2, the gear connection structure 30 connects the driver 20 and the photosensitive drum 10 to thus transmit a drive force (rotative force) of the driver 20 to the photosensitive drum 10. As shown in FIGS. 2 to 5, the gear connection structure 30 includes a rotary shaft 31, a parallel pin 32, and a transmission gear 33 (gear).

### (Rotary Shaft)

For example, the rotary shaft 31 is made of a metallic material and formed in a round bar shape extending in the front-to-rear direction (axial direction). The rotary shaft 31 is supported rotatably about an axis thereof by a metal plate (not shown). The rotary shaft 31 is disposed substantially coaxially with the drum shaft 10A of the photosensitive drum 10 and the front end of the rotary shaft 31 is connected via a coupling 27 to the rear end of the drum shaft 10A (see FIG. 2). A pin hole 34 (see FIG. 4) is formed in a rear portion of the rotary shaft 31. The pin hole 34 is a round hole passing through the rotary shaft 31 in a radial direction thereof orthogonal to the axial direction.

### (Parallel Pin)

As shown in FIG. 4, the parallel pin 32 is, for example, made of a metallic material, formed in a round bar shape, and inserted radially through the pin hole 34 in the rotary shaft 31. The parallel pin 32 inserted through the pin hole 34 extends substantially equal lengths from radially opposite sides across the rotary shaft 31. The inner diameter of the pin hole 34 is slightly larger than the diameter (outer diameter) of the parallel pin 32 and, thus, a slight clearance is left between the inner periphery of the pin hole 34 and the outer periphery of the parallel pin 32 (see FIG. 4).

### (Transmission Gear)

The transmission gear 33 is a spur gear made of, for example, synthetic resin and meshing with a small-diameter portion of the idler gear 25 (see FIG. 2). A central portion of the transmission gear 33 is provided with a pair of cylindrical portions 36 formed to extend on both sides of the transmission gear 33 in the front-to-rear direction (axial direction) (see FIGS. 3 and 5). The pair of cylindrical portions 36 (the transmission gear 33) has a shaft hole 35 formed therein to allow the rear portion of the rotary shaft 31 to pass through the shaft hole 35 (see FIGS. 3 and 4). The shaft hole 35 is a round hole passing through the transmission gear 33 in the axial direction. As shown in FIGS. 3 to 5, a front one of the pair of cylindrical portions 36 is cut away at radially opposite sides thereof to form a pair of slits 37. The inner diameter of the shaft hole 35 is slightly larger than the diameter (outer diameter) of the rotary shaft 31 and, thus, a slight clearance (not shown) is left between the inner periphery of the shaft hole 35 and the outer periphery of the rotary shaft 31.

As shown in FIGS. 3 to 5, the transmission gear 33 is provided with a pin groove 38 formed thereon to allow the parallel pin 32 to be placed inside the pin groove 38. The pin groove 38 is formed at the front surface of the transmission gear 33 to extend on radially opposite sides from the shaft hole 35 (the front cylindrical portion 36). In other words, the pin groove 38 is radially divided into two equal portions by the front cylindrical portion 36. Specifically, the pin groove 38 is formed between a pair of walls 38A and 38B extending radially from radially outside edges of the pair of slits 37 in the front cylindrical portion 36 and frontwardly from the front surface of the transmission gear 33. At each of both ends of the pin groove 38 in the radial direction, respective ends of the pair of walls 38A, 38B are connected by an end wall 38C. The pair of walls 38A, 38B are joined to the front cylindrical portion 36 and the pin groove 38 continues to the slits 37. The pin groove 38 and the slits 37 are formed to have substantially the same width. The widths of the pin groove 38 and the slits 37 are slightly larger than the diameter (outer diameter) of the parallel pin 32. Thus, a slight clearance is left between the inner surfaces of the pin groove 38 (the pair of walls 38A, 38B) and the slits 37 and the outer periphery of the parallel pin 32 (see FIG. 4).

### [Procedure for Connecting Transmission Gear to Rotary Shaft and Others]

A description will be given briefly of the procedure for connecting the transmission gear 33 to the rotary shaft 31 and others. The parallel pin 32 is inserted through the pin hole 34 in the rotary shaft 31 and the rear portion of the rotary shaft 31 is inserted into the cylindrical portions 36 (the shaft hole 35) of the transmission gear 33 from the front. The parallel pin 32 is passed through the slits 37 in the front cylindrical portion 36 and then engaged inside the pin groove 38. For the purpose of restricting axial movement of the transmission gear 33 on the rotary shaft 31, a retaining member (not shown), such as a C-ring, is attached to the rotary shaft 31. In the manner thus far described, the driver 20 is connected through the gear connection structure 30 to the photosensitive drum 10 and can rotate the rotary shaft 31 and the photosensitive drum 10.

As described previously, a slight clearance is present between the inner periphery of the pin hole 34 and the outer periphery of the parallel pin 32 and a slight clearance is also present between the inner surfaces of the pair of walls 38A, 38B and the outer periphery of the parallel pin 32 (see FIG. 4). Therefore, when under these circumstances the rotary shaft 31 is rotated by the driver 20, the rotary shaft 31 runs idle within a range of the slight clearance between the pin hole 34 and the parallel pin 32. Furthermore, the parallel pin 32 starts rotating behind the rotary shaft 31 and runs idle within a range of the slight clearance between the parallel pin 32 and the pin groove 38. In other words, because of these clearances, the rotative force of the rotary shaft 31 may not be able to be efficiently transmitted to the transmission gear 33. In addition, when the parallel pin 32 hits the inner periphery of the pin hole 34 and the inner surfaces of the walls 38A, 38B forming the pin groove 38, disturbing impact noises may be produced.

To cope with the above problems, the gear connection structure 30 according to this embodiment includes a biasing member 40 that biases the parallel pin 32 placed inside the pin groove 38 from one wall 38A toward the other wall 38B. Herein, in the pair of walls 38A, 38B of the pin groove 38, the one wall 38A is referred to also as a “separate wall 38A” and the other wall 38B is referred to also as a “contacting wall 38B”.

### (Biasing Member)

As shown in FIGS. 3 to 5, the biasing member 40 is formed integrally with the front surface (the separate wall 38A) of the transmission gear 33. The biasing member 40 is, for example, a so-called snap-fit member made of an elastically deformable synthetic resin material. The biasing member 40 is provided on a portion of the separate wall 38A located radially away from one side of the shaft hole 35 in the radial direction and on the upstream side of the pin groove 38 in the rotational direction (see the arrows shown in FIG. 4) of the transmission gear 33. The biasing member 40 is formed in a substantially V-shape (or a substantially U-shape) straddling the separate wall 38A as viewed from radially outward (see FIG. 5). The biasing member 40 includes an elastic portion 40A extending from the corner (the front end) of the V-shape toward the back of the pin groove 38. The elastic portion 40A is formed to narrow the width of the pin groove 38 (the distance between the pair of walls 38A and 38B) when the parallel pin 32 is not yet placed inside the pin groove 38. In other words, the distance between the elastic portion 40A and the contacting wall 38B is smaller than the outer diameter of the parallel pin 32.

In the course of placing the parallel pin 32 into the pin groove 38, the elastic portion 40A is compressed (elastically deformed) toward the separate wall 38A (laterally from the pin groove 38) while contacting the parallel pin 32. Thus, the elastic portion 40A is disposed between the parallel pin 32 placed inside the pin groove 38 and the separate wall 38A and contacts the parallel pin 32 with an elastic force. The biasing member 40 (the elastic portion 40A) biases the parallel pin 32 placed inside the pin groove 38 (in the position of the biasing member 40) toward downstream in the rotational direction to press the parallel pin 32 against the contacting wall 38A and against a side of the inner periphery of the pin hole 34 close to the contacting wall 38B (see FIGS. 4 and 5).

The above-described gear connection structure 30 according to this embodiment has a structure in which the parallel pin 32 placed inside the pin groove 38 is biased by the biasing member 40 toward being pressed against the contacting wall 38B and the inner periphery of the pin hole 34. In this structure, the parallel pin 32 can be continuously brought into contact with the contacting wall 38B and the inner periphery of the pin hole 34 and, therefore, micro movement (oscillation) of the parallel pin 32 in the pin groove 38 can be suppressed. Thus, the rotative force of the rotary shaft 31 can be efficiently transmitted to the transmission gear 33. In addition, the parallel pin 32 can be prevented from hitting the inner periphery of the pin hole 34 and the pair of walls 38A, 38B and, therefore, the production of disturbing impact noises can be suppressed.

Furthermore, in the gear connection structure 30 according to this embodiment, the parallel pin 32 is pressed, at a location opposed to the biasing member 40, against the contacting wall 38B located on the downstream side of the pin groove 38 in the rotational direction and, therefore, the rotary shaft 31 and the parallel pin 32 can be integrally rotated. Thus, the rotative force can be efficiently transmitted to the transmission gear 33.

Furthermore, the gear connection structure 30 according to this embodiment has a structure in which the elastic portion 40A of the biasing member 40 formed integrally with the transmission gear 33 is placed between the parallel pin 32 and the separate wall 38A and contacts the parallel pin 32 with an elastic force. With this structure, the parallel pin 32 can become pressed against the contacting wall 38B and the inner periphery of the pin hole 34 simply by placing the parallel pin 32 inside the pin groove 38.

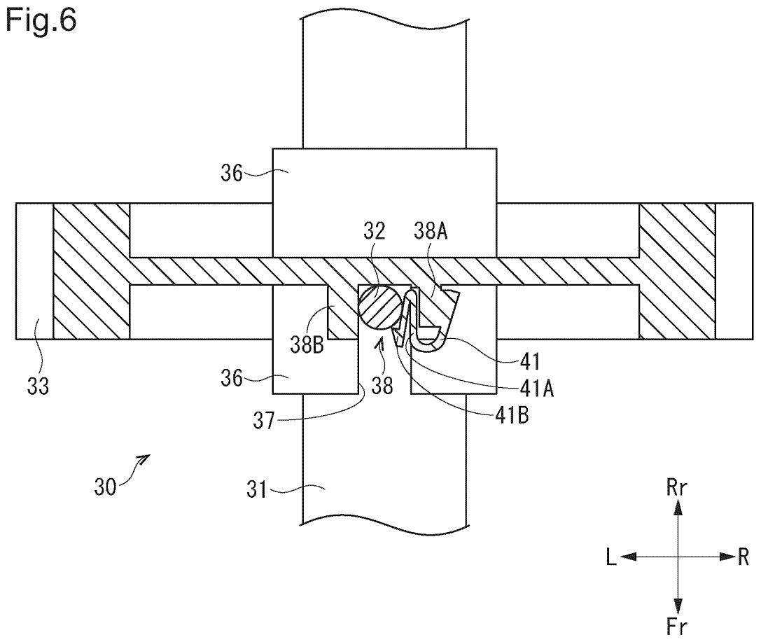

Although in the gear connection structure 30 according to this embodiment the biasing member 40 is formed in a substantially V-shape as viewed from radially outward, the present disclosure is not limited to this. For example, as shown in FIG. 6, a biasing member 41 may be formed in a substantially N-shape as viewed from radially outward (a first modification). An elastic portion 41A of this biasing member 41 may be additionally provided at a free end thereof with a pawl 41B formed in a substantially V-shape as viewed from radially outward to restrain the parallel pin 32 from disengaging from the pin groove 38.

Although in the gear connection structure 30 according to this embodiment (inclusive of the first modification) the biasing member 40, 41 is formed integrally with the transmission gear 33, the present disclosure is not limited to this. The biasing member 40, 41 may be a separate member from the transmission gear 33, in which case, after the parallel pin 32 is placed inside the pin groove 38, the biasing member 40, 41 may be attached to the transmission gear 33 (the separate wall 38A), although not shown.

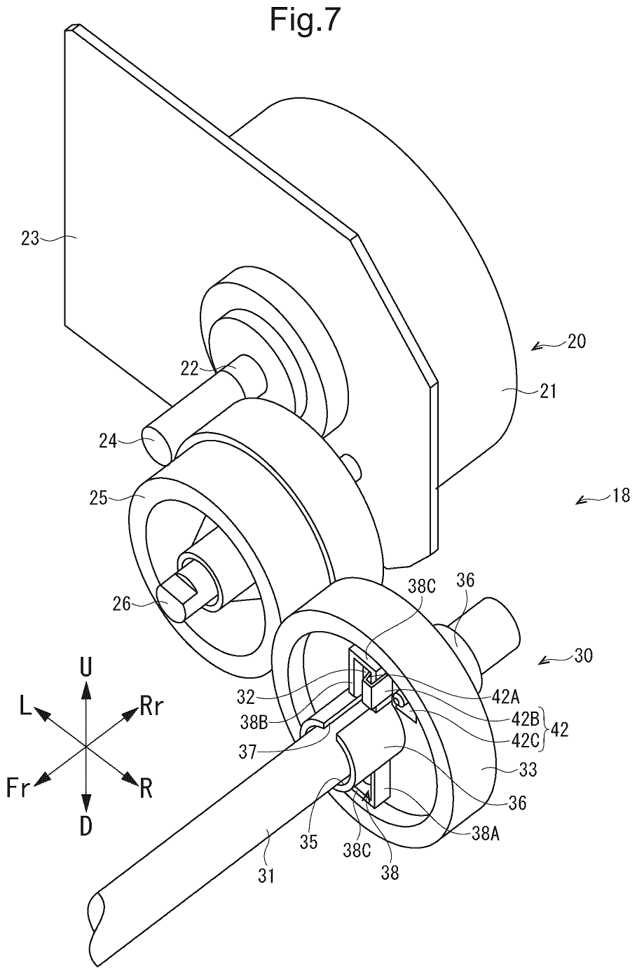

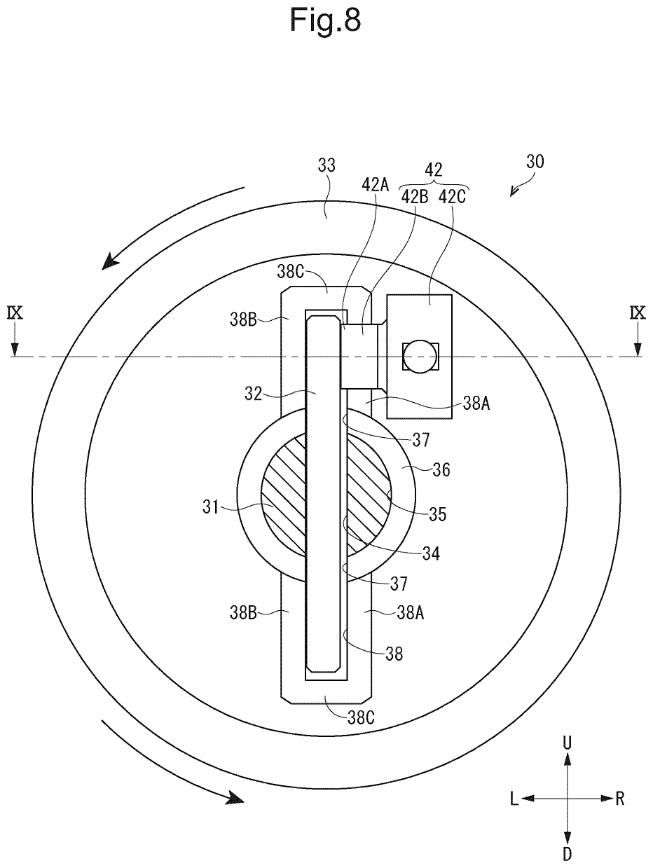

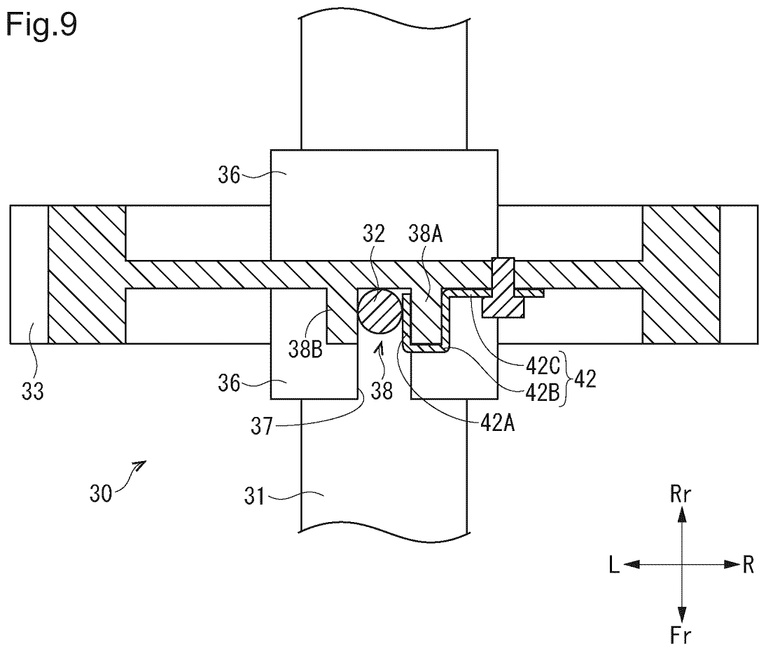

Although in the gear connection structure 30 according to this embodiment (inclusive of the first modification) the biasing member 40, 41 is a so-called snap-fit member, the present disclosure is not limited to this. For example, as shown in FIGS. 7 to 9, a biasing member 42 may be a leaf spring disposed in a compressed state between the parallel pin 32 and the separate wall 38A (a second modification). The biasing member 42 is formed, for example, by bending a metal sheet. The biasing member 42 includes: a biasing member body 42B (including an elastic portion 42A) formed in a substantially U-shape straddling the separate wall 38A as viewed from radially outward; and a fixed portion 42C bent from the biasing member body 42B and secured by a screw or the like to the front surface of the transmission gear 33 (see FIG. 9).

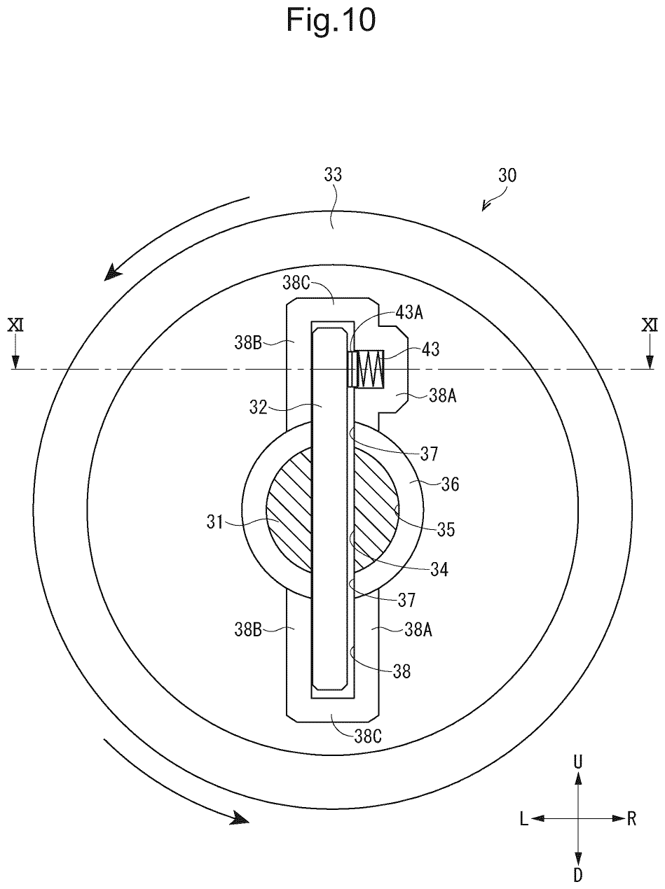

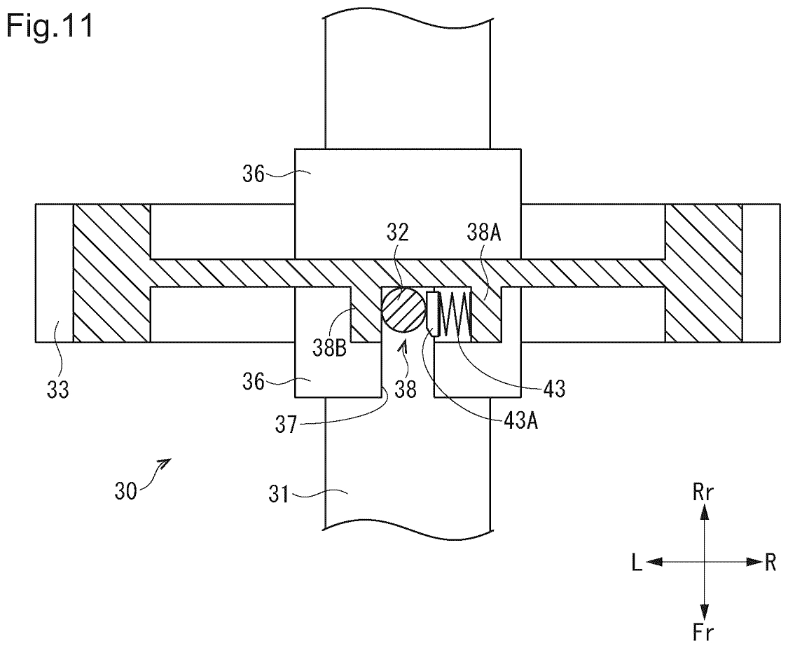

Alternatively, as shown in FIGS. 10 and 11, a biasing member 43 may be a coiled spring disposed in a compressed state between the parallel pin 32 and the separate wall 38A (a third modification). In this case, the separate wall 38A may be bent to secure a space where the biasing member 43 is accommodated. Furthermore, for ease of placing the parallel pin 32 into the pin groove 38, a contact 43A with an inclined surface capable of guiding the placement of the parallel pin 32 may be fixed to a distal end of the biasing member 43. Specifically, in placing the parallel pin 32 into the pin groove 38, the contact 43A positions, within the pin groove 38, the parallel pin 32 in a direction of extension (the axial direction) of the rotary shaft 31.

Although in the gear connection structure 30 according to this embodiment (inclusive of the first to third modifications, the same applies hereinafter) the rotary shaft 31 is connected to the photosensitive drum 10, the present disclosure is not limited to this. The rotary shaft 31 can be connected to, instead of the photosensitive drum 10, another rotating body rotating about an axis thereof, such as, for example, a developing roller (not shown) of the developing device 12 or a fixing roller (not shown) of the fixing device 15.

Since, in the known gear connecting mechanism not according to this embodiment, the projections are mere raised portions provided on the sidewalls of the groove, the projections may contact the parallel pin without a sufficient pressing force due to manufacturing errors (tolerances) of the gear (groove), the parallel pin, and so on. Therefore, the oscillation (micro movement) of the parallel pin in the pin through hole and the groove may not be able to be suitably suppressed. Unlike this gear connecting mechanism, in the above embodiment, the micro movement of the parallel pin can be suppressed.

Although the image forming apparatus 1 according to the above embodiment is a black-and-white printer, the present disclosure is not limited to this and the image forming apparatus 1 may be a multicolor printer, a copier, a facsimile machine or others. Although the image forming manner of the image forming apparatus 1 is an electrophotographic manner, the present disclosure is not limited to this manner and the image forming manner of the image forming apparatus 1 may be an inkjet printing manner.

The description of the above embodiment states an aspect of the gear connection structure, the drive device, and the image forming apparatus according to the present disclosure and, the technical scope of the present disclosure is not limited to the above embodiment. The present disclosure can be changed, substituted, and modified in various ways without departing from the spirit of the technical idea of the present disclosure and the claims appended hereto are intended to cover all embodiments which may fall within the scope of the technical idea of the present disclosure.

What is claimed is:

1. A gear connection structure comprising:
(a) a rotary shaft extending in an axial direction thereof;
(b) a parallel pin inserted through a pin hole formed in the rotary shaft, the pin hole passing through the rotary shaft in a radial direction thereof orthogonal to the axial direction;
(c) a gear including: a shaft hole through which the rotary shaft is passed; and a pin groove inside which the parallel pin is placed; and
(d) a biasing member that biases the parallel pin placed inside the pin groove from a separate wall being one of a pair of walls of the pin groove toward a contacting wall being the other of the pair of walls to press the parallel pin against the contacting wall and against a side of an inner periphery of the pin hole close to the contacting wall.

2. The gear connection structure according to claim 1, wherein
the pin groove is formed to extend on radially opposite sides from the shaft hole, and
the biasing member is provided radially away from the shaft hole on one side in the radial direction and on an upstream side of the pin groove in a rotational direction of the gear and biases the parallel pin toward downstream in the rotational direction.

3. The gear connection structure according to claim 1, wherein the biasing member includes an elastic portion formed integrally with the gear and disposed between the parallel pin and the separate wall, the elastic portion contacting the parallel pin with an elastic force.

4. The gear connection structure according to claim 1, wherein the biasing member is a leaf spring in a compressed state between the parallel pin and the separate wall.

5. The gear connection structure according to claim 1, wherein the biasing member is a coiled spring in a compressed state between the parallel pin and the separate wall.

6. The gear connection structure according to claim 5, wherein
a contact with an inclined surface capable of guiding to place the parallel pin into the pin groove is provided at a distal end of the biasing member, and
the contact positions, within the pin groove, the parallel pin in the axial direction in placing the parallel pin into the pin groove.

7. A drive device comprising:
the gear connection structure according to claim 1; and
a driver that rotates the rotary shaft.

8. An image forming apparatus comprising the drive device according to claim 7.
